(19) United States
(12) Patent Application Publication
(10) Pub. No.: US 2014/0233038 A1
(43) Pub. Date: Aug. 21, 2014

(54) SHAPE MEASUREMENT METHOD, SHAPE MEASUREMENT APPARATUS, PROGRAM, AND RECORDING MEDIUM

(71) Applicant: CANON KABUSHIKI KAISHA, Tokyo (JP)

(72) Inventor: Atsushi Maeda, Utsunomiya-shi (JP)

(21) Appl. No.: 14/181,390

(22) Filed: Feb. 14, 2014

(30) Foreign Application Priority Data
Feb. 19, 2013 (JP) 2013-029575

(51) Int. Cl. G01B 11/24

(52) U.S. Cl. CPC G01B 11/2441
USPC 356/513

(57) ABSTRACT

The present invention is directed to more accurately acquiring shape data than conventional techniques. After an imaging unit images an interference fringe, a calculation unit acquires the captured image from the imaging unit. The calculation unit extracts a ring zone region where the interference fringe is sparse in the captured image from each captured image, and calculates a phase distribution of the interference fringe in each ring zone region. The calculation unit acquires a deviation component having an orientation and an amount both unchangeable along a circumferential direction of a circle centered at the optical axis of the subject light by analyzing the interference fringe contained in each acquired captured image. Further, the calculation unit calculates positions of characteristic points of a calibrator, and calculates a distortion component. Then, the calculation unit calculates the shape data corrected based on the deviation component and the distortion component.

### BACKGROUND OF THE INVENTION

1. Field of the Invention

The present invention relates to a shape measurement method, a shape measurement apparatus, a program, and a recording medium for acquiring shape data of an aspheric subject surface.

2. Description of the Related Art

In recent years, aspheric optical elements have been often used for optical apparatuses such as cameras, optical drives, and exposure apparatuses. Further, with the improvement of accuracy of these optical apparatuses, the aspheric optical elements have been achieving increases in both height accuracy and lateral coordinate accuracy. For example, lenses used in cameras for professional use should have height accuracy of at least 20 nm and lateral coordinate accuracy of at least 50 μm.

Realization of such high shape accuracy requires a shape measurement apparatus that can highly accurately measure a shape of an aspheric lens surface.

Japanese Unexamined Patent Application Publication (Translation of PCT Application) No. 2008-532010 discusses a scanning interferometer as one of this type of apparatus. The scanning interferometer is configured to measure a shape of a whole subject surface by scanning the subject surface along an optical axis of the interferometer. The scanning interferometer forms an interference fringe by causing reference light reflected from a reference spherical surface and subject light reflected from the subject surface to interfere with each other. Then, the scanning interferometer analyzes the interference fringe to acquire a phase, and acquires the shape of the subject surface based on the phase.

To acquire the phase accurately from the analysis of the interference fringe, a spatial change in the intensity of the interference light should be gradual, i.e., the interference fringe should be in a sparse state. To achieve this state, the two light beams that form the interference light should travel in directions substantially parallel with each other. However, the reference light, which is one of the two wave fronts that form the interference light on the reference spherical surface, is a spherical wave and another subject light is an aspheric wave. Therefore, it is impossible that this condition can be satisfied over the whole region of the wave front of the interference light. This condition is satisfied only on a partial region corresponding to the subject light reflected substantially perpendicular from the subject surface, and this region is generated as a ring zone if the subject surface is axially symmetrical. Therefore, the phase of the interference fringe can be accurately calculated only in this ring zone region.

Scanning the subject surface relative to the reference spherical surface in a direction along the optical axis of the interferometer changes the radius of the ring zone region where the interference fringe is sparse according to the scanning position. The measurement is performed by repeatedly moving the subject surface and imaging the interference fringe by an imaging unit. As a result, the phase of the interference fringe over the whole subject surface can be acquired as a plurality of divided ring zone regions.

To form shape data of the whole subject surface, first, phase data of an interference fringe in a further narrow ring zone region where the phase has an extremal value is extracted from a phase distribution of each of the interference fringes as the ring zones. After that, height data of the plurality of ring zones is calculated by multiplying a phase value by a value of a wavelength of a light source, thereby forming the shape data.

As described above, the measurement of the shape of the optical element requires not only high accuracy as to height but also high lateral coordinate accuracy. One of causes for a reduction in lateral coordinate accuracy of the scanning interferometer is an aberration of an optical system of the scanning interferometer. A lateral aberration may be generated due to, for example, a wrong placement of the optical element in the scanning interferometer, leading to generation of a distortion of 100 μm or more in the interference fringe, resulting in an error in lateral coordinates in the shape data. The error in the lateral coordinates due to such an aberration of the optical system should be eliminated in order to highly accurately measure the shape.

One possible method therefor is adopting a method discussed in Japanese Patent Application Laid-Open No. 9-61121 in the scanning interferometer. More specifically, first, a mask having a plurality of apertures formed at known positions is placed over a standard device having an aspheric surface shaped in a similar manner to the subject surface, and this device is used as a calibrator. These apertures serve as characteristic points of the calibrator.

Next, this calibrator is scanned along the optical axis of the interferometer in a similar manner to the subject surface, and the positions of the apertures are read out at respective scanning positions during scanning. After that, lateral coordinates are calibrated with respect to the phase data of each interference fringe using the read aperture positions as lateral coordinate references. Then, shape data is formed from results thereof.

However, the positions of the characteristic points read out during the calibration contain a distortion due to a deviation of a scanning axis when the calibrator is scanned. This distortion is generated only due to an error in alignment of the calibrator, and is not contained in the data acquired by scanning the subject surface. Therefore, the above-described method leads to an erroneous correction of the distortion due to the deviation of the scanning axis.

### SUMMARY OF THE INVENTION

The present invention is directed to a shape measurement method, a shape measurement apparatus, a program, and a recording medium that allow shape data to be more accurately acquired than conventional techniques.

According to an aspect of the present invention, a shape measurement method includes emitting subject light as a spherical wave to an aspheric subject surface, causing the subject surface to be scanned relative to a reference spherical surface that faces the subject surface along an optical axis of the subject light, and acquiring shape data of the subject surface by a calculation unit based on phase data of an interference fringe generated when the subject light reflected by the subject surface and reference light reflected by the reference spherical surface interfere with each other. The shape measurement method further includes causing an imaging unit to image the interference fringe generated from interference between the subject light and the reference light at each scanning position when the subject surface is scanned relative to the reference spherical surface along the optical axis of the subject light to form a captured image, causing the calculation unit to acquire the captured image from the imaging unit, performing a phase distribution calculation in which the calculation unit extracts a ring zone region where the interference fringe is sparse in the captured image from each captured image acquired in the image acquisition, and calculates a phase distribution of the interference fringe in each ring zone region, performing a deviation component analysis in which the calculation unit acquires a deviation component having an orientation and an amount both unchangeable along a circumferential direction of a circle centered at the optical axis of the subject light by analyzing the interference fringe contained in each image captured in the image acquisition, performing calibrator image acquisition in which, after the imaging unit images an interference fringe generated from interference between reflection light from a calibrator and reflection light from the reference special surface at each scanning position when the calibrator having a plurality of characteristic points is scanned relative to the reference spherical surface to form a captured image, the calculation unit acquires the captured image from the imaging unit, causing the calculation unit to calculate positions of the respective characteristic points from each captured image acquired in the calibrator image acquisition, causing the calculation unit to calculate errors between the calculated positions of the respective characteristic points and actual positions of the respective characteristic points, performing a distortion component calculation in which the calculation unit calculates a distortion component having an orientation and an amount, at least one of which is changeable along the circumferential direction of the circle centered at the optical axis of the subject light, based on the errors, and causing the calculation unit to calculate the shape data corrected based on the deviation component and the distortion component.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 schematically illustrates an outline of a configuration of a shape measurement apparatus according to a first exemplary embodiment.

FIG. 2 is a block diagram illustrating a configuration of a controller of the shape measurement apparatus according to the first exemplary embodiment.

FIG. 3 is a flowchart illustrating a shape measurement method performed by the shape measurement apparatus according to the first exemplary embodiment.

FIG. 4 schematically illustrates an interference fringe acquired by a scanning interferometer illustrated in FIG. 1.

FIG. 5 schematically illustrates a relationship between a shape of a subject surface and a spherical wave.

FIGS. 6A to 6E schematically illustrate deviation components and distortion components contained in shape data acquired by the scanning interferometer.

FIG. 7 schematically illustrates a mask used for a calibrator.

FIG. 8 is a flowchart illustrating a shape measurement method performed by a shape measurement apparatus according to a second exemplary embodiment.

FIG. 9 is a front view of a subject used in shape measurement according to the second exemplary embodiment.

FIG. 10 schematically illustrates a placement of a subject surface when the subject surface is scanned according to the second exemplary embodiment.

FIG. 11 is a flowchart illustrating a shape measurement method performed by a shape measurement apparatus according to a third exemplary embodiment.

### DESCRIPTION OF THE EMBODIMENTS

Various exemplary embodiments, features, and aspects of the invention will be described in detail below with reference to the drawings.

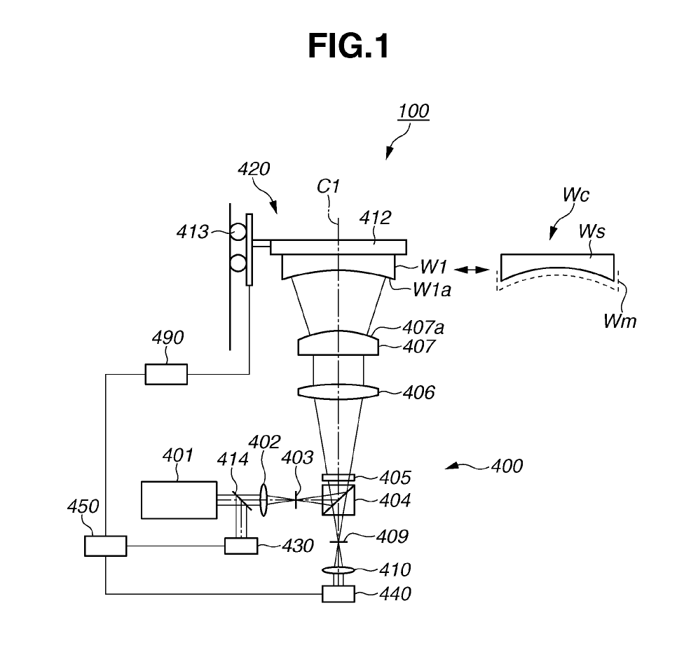

FIG. 1 schematically illustrates an outline of a configuration of a shape measurement apparatus according to a first exemplary embodiment of the present invention. The shape measurement apparatus 100 includes a scanning interferometer 400, a digital camera (hereinafter referred to as a “camera”) 440, which corresponds to an imaging unit, and a controller 450, which constitutes a computer. A subject W1 is an optical element such as a lens, and a subject surface W1a of the subject W1 is a surface of the optical element such as the lens. The subject surface W1a is formed as an axially symmetrical aspheric surface. The camera 440 is a digital still camera that includes an image sensor such as a charge coupled device (CCD) or a complementary metal-oxide semiconductor (CMOS), and captures an image by imaging an object.

The scanning interferometer 400 includes a laser light source 401 as a light source, a beam splitter 414, and a wavemeter 430. A linearly-polarized plane wave is emitted from the laser light source 401. A part of this light is transmitted through the beam splitter 414, and a part of this light is reflected to be incident on the wavemeter 430.

Further, the scanning interferometer 400 includes a lens 402, an aperture plate 403 having an aperture, a polarized beam splitter 404, a quarter-wave plate 405, a collimator lens 406, a Fizeau lens 407, an aperture lens 409 having an aperture, and a lens 410. Further, the scanning interferometer 400 includes a movement mechanism 420 as a scanning unit, and a driving device 490 that drives and controls the movement mechanism 420.

The laser light transmitted through the beam splitter 414 is converted into a circularly-polarized plane wave having an increased beam diameter by passing through the lens 402, the aperture of the aperture plate 403, the polarized beam splitter 404, the quarter-wave plate 405, and the collimator lens 406.

The Fizeau lens 407 has a reference spherical surface 407a that faces the subject surface W1a. The plane wave transmitted through the collimator lens 406 is incident on the Fizeau lens 407, and is converted into a spherical wave by the time when it reaches the reference spherical surface 407a. The reference spherical surface 407a is a spherical surface, and a center thereof coincides with a center of the spherical wave incident on the reference spherical surface 407a. In other words, the spherical wave is incident perpendicularly to the reference spherical surface 407a over the whole region. A part of the spherical wave incident on the reference spherical surface 407a is reflected by the reference spherical surface 407a as reference light, and a part of the spherical wave is transmitted through the reference spherical surface 407a as subject light.

The reference light is perpendicularly reflected by the reference spherical surface 407a, thereby traveling as a spherical wave even after the reflection, similar to the reference light before the entry into the reference spherical surface 407a. The subject light transmitted through the reference spherical surface 407a is a spherical wave but becomes an aspheric wave after reflected by the subject surface W1a of the subject W1, and is then incident on the reference spherical surface 407a again. A part of the subject light incident on the reference spherical surface 407a again is transmitted through the reference spherical surface 407a, and is combined with the reference light reflected from the reference spherical surface 407a, by which interference light, i.e., an interference fringe is generated.

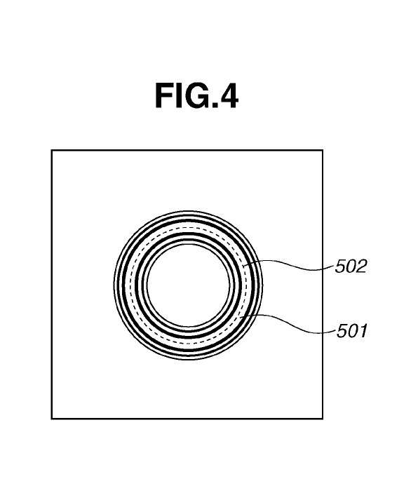

The interference light combined on the reference spherical surface 407a is converted into a circular-polarized plane wave by passing through the Fizeau lens 407. After that, the interference light is converted into a linearly-polarized plane wave having a reduced beam diameter after passing through the collimator lens 406, the quarter-wave plate 405, the polarized beam splitter 404, the aperture of the aperture plate 409, and the lens 410. The camera 440 is in an imaging relationship with the subject surface W1, and an image of an interference fringe 501 illustrated in FIG. 4 is captured.

The movement mechanism 420 includes a movable stage 412 on which the subject W1 or a calibrator Wc as a lateral coordinate calibrator is mounted, and a lead 413 fixed to the movable stage 412. The movement mechanism 420 can move the subject W1 or the calibrator Wc along an optical axis C1 of the Fizeau lens 407.

The subject surface W1a is processed based on an axially symmetric design shape z₀(h), and is placed in such a manner that an axis of the subject surface W1a substantially coincides with an optical axis of the interferometer 400, i.e., the optical axis C1 of the Fizeau lens 407.

Further, a position of the subject W1 in a direction perpendicular to the optical axis C1, and an angle of the subject W1 relative to the optical axis C1 can be finely adjusted by the movable stage 412. Further, the subject W1 is scanned along the optical axis C1 by the lead 413.

The present exemplary embodiment is based on a case in which the subject surface W1a of the subject W1 is scanned relative to the reference spherical surface 407a, but scanning may be carried out in any manner as long as relative scanning is achieved between the subject surface W1a and the reference spherical surface 407a. In other words, the reference spherical surface 407a may be scanned relative to the subject surface W1a, or both of the surfaces 407a and W1a may be scanned. In this case, the whole interferometer 400 may be scanned, or only the Fizeau lens 407 may be scanned.

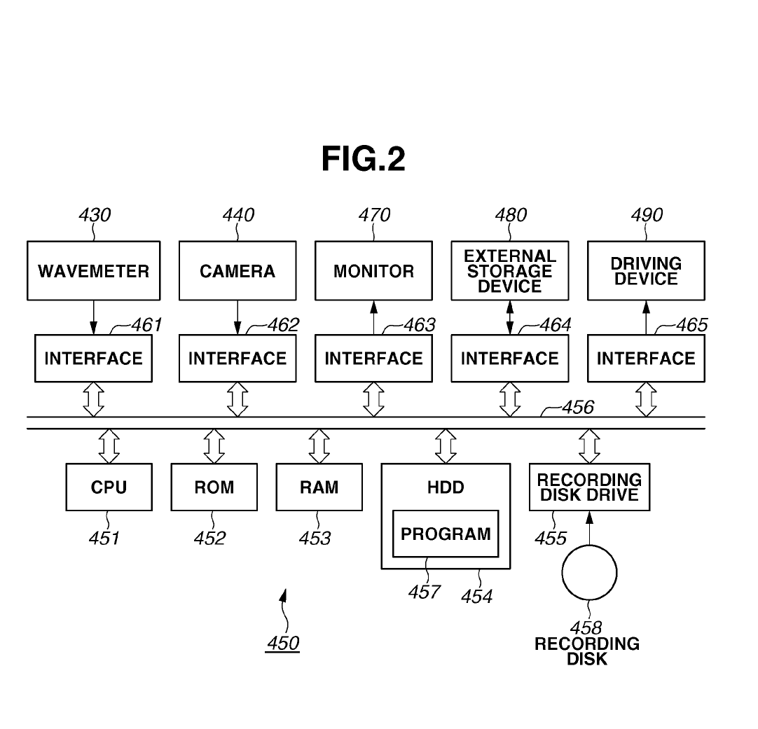

FIG. 2 is a block diagram illustrating a configuration of the controller 450 of the shape measurement apparatus 100. The controller 450 includes a central processing unit (CPU) 451 as a calculation unit, a read only memory (ROM) 452, a random access memory (RAM) 453, a hard disk drive (HDD) 454 as a storage unit, a recording disk drive 455, and various kinds of interfaces 461 to 465.

The ROM 452, the RAM 453, the HDD 454, the recording disk drive 455, and the various kinds of interfaces 461 to 465 are connected to the CPU 451 via a bus 456. The ROM 452 stores a basic program such as a Basic Input/Output System (BIOS). The RAM 453 is a storage device that temporarily stores a result of calculation made by the CPU 451.

The HDD 454 is a storage unit that stores, for example, various kinds of data that are results of the calculation made by the CPU 451. In addition, the HDD 454 stores a program 457 for causing the CPU 451 to perform various kinds of calculation processing, which will be described below. The CPU 451 performs the various kinds of calculation processing based on the program 457 recorded (stored) in the HDD 454.

The recording disk drive 455 can read out various kinds of data, a program, and the like recorded in a recording disk 458.

The wavemeter 430 is connected to the interface 461. The wavemeter 430 measures an emission wavelength of the laser light source 401, and outputs a result of the measurement. The CPU 451 receives a signal that indicates the wavelength data from the wavemeter 430 via the interface 461 and the bus 456.

The camera 440 is connected to the interface 462. The camera 440 outputs a signal that indicates a captured image. The CPU 451 receives the signal that indicates the captured image from the camera 440 via the interface 462 and the bus 456.

A monitor 470 is connected to the interface 463. Various kinds of images (for example, the image captured by the camera 440) are displayed on the monitor 470. An external storage device 480 such as a rewritable nonvolatile memory or an external HDD is connected to the interface 464. The driving device 490 is connected to the interface 465. The CPU 451 controls the lead 413, and thus scanning of the subject W1 or the calibrator We via the driving device 490 is controlled.

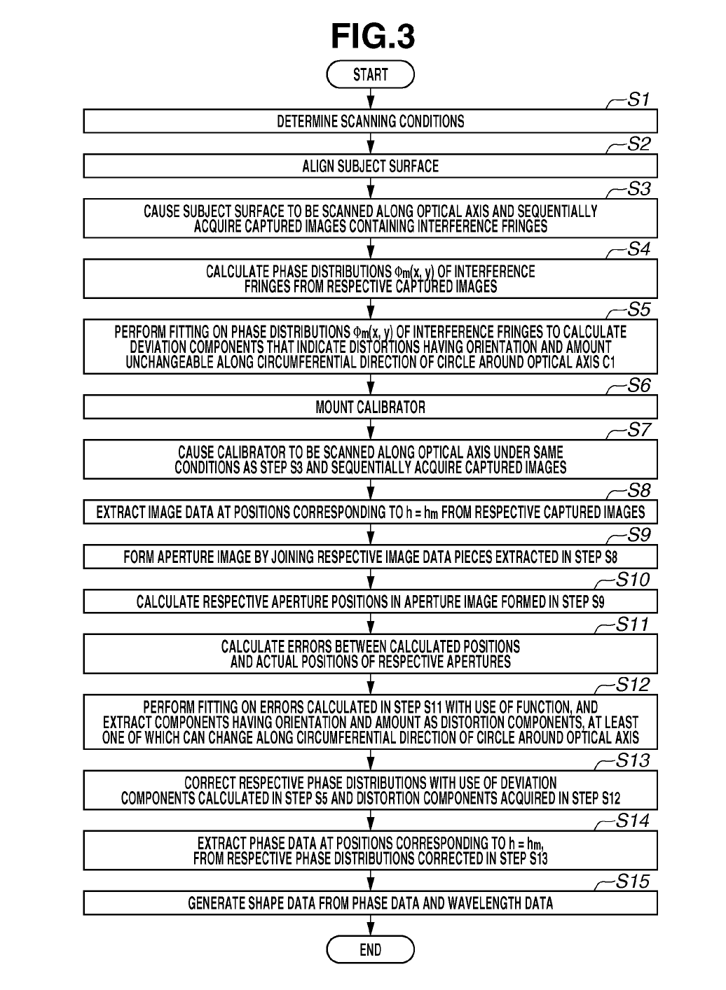

FIG. 3 is a flowchart illustrating a shape measurement method performed by the shape measurement apparatus according to the first exemplary embodiment. In the following description, the present exemplary embodiment will be described according to the flowchart of FIG. 3.

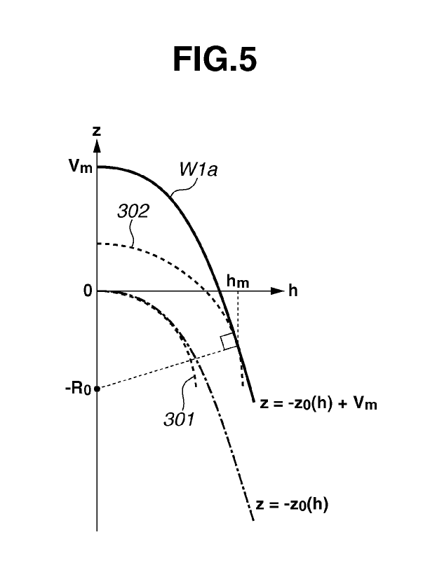

First, in step S1, the number of scanning steps N (N is a positive integer of 2 or more), and a position Vₘ of the subject surface W1a in each scanning step m (m=1, 2, . . . , N) are determined as scanning conditions when the subject W1 is scanned. This position Vₘ is defined as a distance in the direction along the optical axis C1 from a position where a curvature radius of a light wave front (a spherical wave 301) contacting a top of the subject surface W1a is equal to a curvature radius Ro of the subject surface W1a at the top of the subject surface W1a (refer to FIG. 5). In FIG. 5, h represents a distance from the optical axis C1 in the direction perpendicular to the optical axis C1. When the subject surface W1a is located at the position Vₘ, a spherical wave 302 is radiated as illustrated in FIG. 5, and the subject surface W1a and the spherical wave 302 have an equal curvature radius at a position corresponding to a distance h=hₘ. At this time, the distance hₘ and the position Vₘ are in the following relationship.

$${z}_{0} ( {h}_{m} ) - ( {v}_{m} + {R}_{0} ) = - \frac{{h}_{m}}{\frac{d {z}_{0} ( h )}{d h} {\vert}_{h = {h}_{m}}} \qquad EQUATION ( 1 )$$

It is desirable that the position Vₘ in each step m is determined in such a manner that the distance hₘ scans the whole subject surface W1a at an equal interval in light of the relationship expressed by the equation (1). Further, it is desirable that the number of scanning steps N is determined according to a lateral coordinate resolution required for intended shape data.

After the scanning conditions are determined, in step S2, the subject W1 is aligned in such a manner that an axis (an optical axis) of the aspheric surface of the subject surface W1a coincides with the optical axis C1. At this time, the position and the angle of the subject W1 are adjusted by operating the stage 412 while observing the interference fringe.

After the subject W1 is aligned, in step S3, the CPU 451 moves the subject W1 to a first measurement position Vₘ₌₁ along the optical axis C1, and then captures an image of an interference fringe Iₘ₌₁(x, y) on the camera 440 while measuring a wavelength λₘ₋₁(x, y) of the laser light source 401 by the wavemeter 430. Here, (x, y) represents an orthogonal coordinate system (an imaging coordinate system) on the camera 440. After that, the CPU 451 repeats a movement of the subject W1 to the position Vₘ, capturing the image of the interference fringe Iₘ(x, y), and measurement of the wavelength λₘ according to the scanning conditions. In other words, in step S3, the camera 440 captures the image of the interference fringes generated from interference between the subject light and the reference light at the respective scanning positions when the subject surface W1a is scanned relative to the reference spherical surface 407a along the optical axis C1 of the subject light to capture the image, and the CPU 451 acquires the captured images from the camera 440. Further, in step S3, the CPU 451 acquires the wavelength data from the wavemeter 430 in addition to acquiring the captured images from the camera 440. This step S3 is an image acquisition process and a wavelength acquisition process, i.e., image acquisition processing and wavelength acquisition processing, which are performed by the CPU 451.

After acquiring the image data of the interference fringes and the wavelength data through all relevant steps in step S4, the CPU 451 calculates phase distributions of the interference fringes from the respective interference fringes (a phase distribution calculation step or phase distribution calculation processing). Because an interference fringe 501 formed by reflection light around a position corresponding to h=hₘ among the reflection light from the subject surface W1a is sparse (FIG. 4), a phase distribution can be calculated. The CPU 451 calculates an interference fringe phase distribution Φₘ(x, y) in this annular ring zone region. In other words, the CPU 451 extracts ring zone regions where the interference fringes are sparse in the captured images with regard to the respective captured images acquired in step S3 and calculates the interference fringe phase distributions Φₘ(x, y) in the respective ring zone regions. The each phase distribution Φₘ(x, y) is partial phase distributions each shaped as a ring zone.

In calculating the shape data, the CPU 451 uses only a phase φₘ of an interference fringe on a circle 502 illustrated in FIG. 4, which is formed by the reflection light at a position corresponding to h=hₘ on the subject surface W1a, among the interference fringe phase distributions Φₘ(x, y) shaped as a ring zone. A relationship between coordinates (x, y) on the camera 440 and coordinates (X, Y) on the subject surface W1a should be correctly recognized to accurately extract data corresponding to h=hₘ. These coordinate systems stand substantially in the following relationship, assuming that k represents a magnification of an optical system that projects the interference fringes onto the camera 440.

$$[ \begin{matrix}X \\ Y\end{matrix} ] \approx k [ \begin{matrix}x \\ y\end{matrix} ] \qquad EQUATION ( 2 )$$

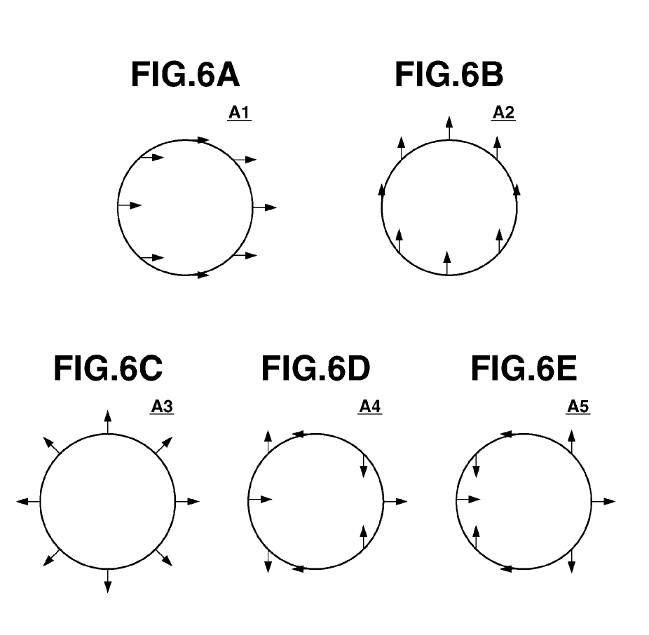

However, actually, deviation components A1 and A2 illustrated in FIGS. 6A and 6B are generated due to a deviation of the scanning axis and an aberration of the optical system of the interferometer 400, and distortion components A3 to A5 illustrated in FIGS. 6C to 6E are generated due to the aberration of the optical system of the interferometer 400. These distortions are not taken into consideration in the equation (2). Therefore, according to the present exemplary embodiment, the CPU 451 acquires these components A1 to A5, and corrects the equation (2) accordingly.

First, the CPU 451 calculates and corrects these deviation components A1 and A2 that indicate the distortions illustrated in FIGS. 6A and 6B due to the deviation of the scanning axis and the aberration of the optical system, which are contained in each of the interference fringe phase distributions Φₘ(x, y). These deviation components A1 and A2 are components having an orientation and an amount both unchangeable along a circumferential direction of a circle centered at the optical axis C1, and correspond to a parallel movement of (x_{0,m}, y_{0,m}), i.e., an origin deviation of lateral coordinates. Therefore, in step S5, the CPU 451 calculates the deviation components A1 and A2 illustrated in FIGS. 6A and 6B by analyzing the interference fringes contained in the respective captured images acquired in step S3 (a deviation component analysis step, deviation component analysis processing). In this step S5, the CPU 451 calculates deviation amounts of central axes of the respective phase distributions from a reference point as the deviation components. In other words, the shape of the subject surface W1a is axially symmetric, whereby the interference fringe phases Φₘ(x, y) are also axially symmetric, and the CPU 451 calculates the origin deviations of the lateral coordinates by acquiring the positions of these axes.

More specifically, the CPU 451 substitutes r={square root over ([x−x_{0,m})²+(y−y_{0,m})²])} into an appropriate function g (r) such as a polynomial equation, and performs fitting on the respective interference fringe phases Φₘ(x, y) while changing x_{0,m} and y_{0,m}. The CPU 451 corrects the equation (2) by x_{0,m} and y_{0,m} calculated in this manner, thereby acquiring an equation (3).

$$[ \begin{matrix}X \\ Y\end{matrix} ] \approx k [ \begin{matrix}x - {x}_{0 , m} \\ y - {y}_{0 , m}\end{matrix} ] \qquad EQUATION ( 3 )$$

In this manner, the deviation components A1 and A2 that indicate the distortions illustrated in FIGS. 6A and 6B in the respective phase distributions Φₘ(x, y) can be corrected.

Next, the CPU 451 calculates the distortion components A3 to A5 illustrated in FIGS. 6C to 6E, which are contained in the interference fringe phases Φₘ(x, y), with use of the calibrator Wc (FIG. 1). An aspheric standard device Ws having a shape similar to the subject W1 is covered with a mask Wm having a plurality of apertures, and this device is used as the calibrator Wc.

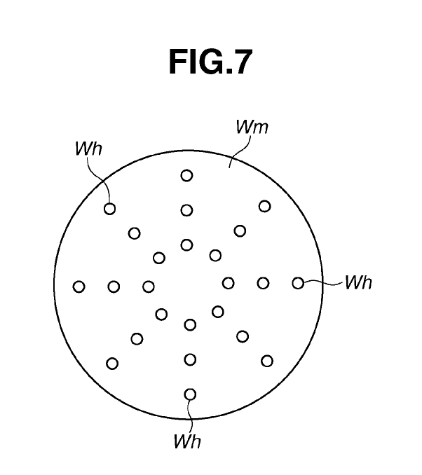

FIG. 7 illustrates the mask Wm used in the present first exemplary embodiment. As illustrated in FIG. 7, a plurality of apertures Wh is formed at the mask Wm so as to be concentrically arranged, and are located at (pΔh, qΔθ)(p=1, . . . , P−1, P, and q=1, . . . , 2π/Δθ−1, 2π/Δθ) in a polar coordinate system. FIG. 7 illustrates the mask Wm with the settings of P=3 and Δθ=π/4. These apertures Wh function as lateral coordinate reference points, i.e., characteristic points. Besides this configuration, the calibrator Wc can be configured in various manners, and is not limited to this configuration. For example, regarding the positions of the apertures, if the apertures are concentrically placed, the values of P and Δ θ may be different from the mask illustrated in FIG. 7. Further, the apertures may be arranged in a square lattice. Further, reference marks may be directly provided to the aspheric standard device Ws without covering the standard device Ws with the mask Wm.

The specific procedure for calibrating the lateral coordinates will be described now. First, in step S6, the calibrator Wc is mounted on the movable stage 412 in such a manner that an optical axis of the calibrator Wc (the aspheric standard device Ws) coincides with the optical axis C1 as close as possible. Because an observable interference fringe has only a small area so that it is difficult to align the calibrator Wc while observing the interference fringe, a mechanical abutting member or the like is utilized to mount the calibrator Wc. At this time, it is expected that the optical axis of the calibrator Wc deviates from the optical axis C1 by approximately 100 μm, but an influence of this offset is removed later so that this does not cause a problem.

Next, in step S7, the calibrator Wc is scanned under the same conditions as the scanning of the subject surface W1a. The CPU 451 acquires captured images I′ₘ(x, y) imaged by the camera 440 in the respective scanning steps m (a calibrator image acquisition step or calibrator image acquisition processing). More specifically, the camera 440 images interference fringes generated by the reflection light from the calibrator Wc and reflection light from the reference spherical surface 407a at the respective scanning positions when the calibrator We is scanned relative to the reference spherical surface 407a to capture images I′ₘ(x, y), and the CPU 451 acquires the captured images I′ₘ(x, y) from the camera 440. In these captured images I′ₘ(x, y), light is not detected in regions covered by the mask Wm, and light is detected only in regions in the apertures.

Further, in step S8, the CPU 451 extracts I′ₘ(x_{0,m}+(hₘ/k)cos θ, y_{0,m}+(hₘ/k)sin θ) from the respective captured images I′ₘ(x, y), converts them into the coordinate system of the subject surface W1a, and sets them as I′ₘ(hₘ cos θ, hₘ sin θ).

The images extracted here are images at positions that substantially coincide with the circle 502 illustrated in FIG. 4, and substantially correspond to positions of h=hₘ on the subject surface W1a. In step S9, the CPU 451 acquires an aperture image in the coordinate system of the subject surface W1a by joining the image data pieces in the respective scanning steps m.

After that, in step S10, the CPU 451 calculates central positions X_{p,q} and Y_{p,q} of the respective apertures from the aperture image, i.e., the positions of the characteristic points. In other words, the CPU 451 calculates the positions of the respective apertures, which are the respective characteristic points, based on the respective captured images acquired in step S7 by the processes in steps S8 to S10 (a characteristic point position calculation step, or characteristic point position calculation processing).

Next, in step S11, the CPU 451 calculates errors between the calculated positions of the respective apertures (the characteristic points) and the actual positions of the respective apertures (the actual positions of the respective characteristic points) (an error calculation step, or error calculation processing). More specifically, the CPU 451 calculates differences ΔX (pΔh, qΔθ) in an X direction and differences ΔY (pΔh, qΔθ) in a Y direction between the calculated positions of the apertures and the actual positions of the apertures according to an equation (4). The actual positions of the apertures (the actual positions of the characteristic points) may be stored in a storage unit such as the HDD 454 in advance and may be read out by the CPU 451 from the storage unit, or may be acquired from an external apparatus. Alternatively, the CPU 451 may calculate them based on data of p, q, Δh, and Δθ.

$$[ \begin{matrix}Δ X ( p Δ h , q Δ θ \\ Δ Y ( p Δ h , q Δ θ\end{matrix} ] = [ \begin{matrix}{X}_{p , q} - p Δ h cos ( q Δ θ ) \\ {Y}_{p , q} - p Δ h cos ( q Δ θ )\end{matrix} ] \qquad EQUATION ( 4 )$$

In this equation, ΔX(pΔh, qΔθ) and ΔY(pΔh, qΔθ) are distortion data that contains the distortion components A3 to A5 due to the aberration of the optical system, which correspond to FIGS. 6C to 6E, and the deviation components A1 and A2 due to the deviation of the scanning axis of the calibrator Wc, which correspond to FIGS. 6A and 6B. However, the lateral coordinate error due to the deviation of the scanning axis of the calibrator Wc is not contained in the interference fringe phase distributions and the shape data of the subject surface W1a. Therefore, the components A1 and A2 illustrated in FIGS. 6A and 6B in the distortion data ΔX(pΔh, qΔθ) and ΔY(pΔh, qΔθ) cannot be used for the correction. Therefore, the CPU 451 extracts only the components (the distortion components) A3 to A5 illustrated in FIGS. 6C to 6E, which allow an accurate correction to be made, and uses them for the correction.

In step S12, the CPU 451 fits to the errors ΔX(pΔh, qΔθ) and ΔY(pΔh, qΔθ) a fitting function of an equation (5), which contains a function corresponding to the distortion components each having an orientation and an amount, at least one of which is changeable along the circumferential direction of the circle centered at the optical axis C1 of the subject light. Then, the CPU 451 calculates the distortion components from the functions of the equation (5) after the fitting and an equation (7) (a distortion component calculation step, or distortion component calculation processing). In other words, the CPU 451 performs fitting on the errors ΔX(pΔh, qΔθ) and ΔY(pΔh, qΔθ) with use of the function of the equation (5) to extract the distortion components.

$$\begin{matrix}[ \begin{matrix}Δ X ( h , θ ) \\ Δ Y ( h , θ )\end{matrix} ] = [ \begin{matrix}{f}_{X , ab} ( h ) \\ {f}_{Y , ab} ( h )\end{matrix} ] + [ \begin{matrix}{f}_{X , cde} ( h , θ ) \\ {f}_{Y , cde} ( h , θ )\end{matrix} ] & EQUATION ( 5 ) \\ [ \begin{matrix}{f}_{X , ab} ( h ) \\ {f}_{Y , ab} ( h )\end{matrix} ] = {\sum }_{j = 0 , 1 , 2} {k}_{a , j} {h}^{j} [ \begin{matrix}1 \\ 0\end{matrix} ] + {\sum }_{j = 0 , 1 , 2} {k}_{b , j} {h}^{j} [ \begin{matrix}0 \\ 1\end{matrix} ] & EQUATION ( 6 ) \\ [ \begin{matrix}{f}_{X , cde} ( h , θ ) \\ {f}_{Y , cde} ( h , θ )\end{matrix} ] = {\sum }_{j = 1 , 3 , 5} {k}_{c , j} {h}^{j} [ \begin{matrix}cos θ \\ sin θ\end{matrix} ] + {k}_{d , 2} {h}^{2} [ \begin{matrix}cos ( - 2 θ ) \\ sin ( - 2 θ )\end{matrix} ] + {k}_{e , 2} {h}^{2} [ \begin{matrix}cos ( 2 θ ) \\ sin ( 2 θ )\end{matrix} ] & EQUATION ( 7 )\end{matrix}$$

In the above-described equations, f_{X,ab}(h) and f_{Y,ab}(h) are functions defined by the equation (6), and the first and second terms on the right side of the equation (6) correspond to the components illustrated in FIGS. 6A and 6B, respectively. These functions do not depend on the variable θ, and indicate components each having an orientation and an amount both unchangeable along the circumferential direction. The variable h represents a distance from the optical axis C1 in the direction perpendicular to the optical axis C1, and the variable θ represents an angle around the optical axis C1.

In the above-described equations, f_{X,cde}(h, θ) and f_{Y,cde} (h, θ) are functions defined by the equation (7). The first, second, and third terms on the right side of the equation (7) correspond to FIGS. 6C, 6D, and 6E, respectively. All of the respective terms in this function contain the variable θ, and represent components each having an orientation and an amount changeable along the circumferential direction.

The CPU 451 performs fitting by changing coefficients k_{a,j}, k_{b,j}, k_{c,j}, k_{d,2}, and k_{e,2} with use of these functions. Then, the CPU 451 extracts the component (f_{X,cde}(h, θ) and f_{Y,cde} (h, θ)) having an orientation and an amount, at least one of which is changeable along the circumferential direction, from the lateral coordinate error (ΔX, ΔY).

The relationship between the coordinates (x, y) on the camera 440 and the coordinates (X, Y) on the subject surface W1a can be expressed anew by an equation (8) with use of the extracted lateral coordinate error component.

$$[ \begin{matrix}X \\ Y\end{matrix} ] = [ \begin{matrix}k ( x - {x}_{0 , m} ) + {f}_{X , cde} ( k \sqrt{\begin{matrix}{( x - {x}_{0 , m} )}^{2} + \\ {( y - {y}_{0 , m} )}^{2}\end{matrix}} , {Tan}^{- 1} ( \frac{y - {y}_{0 , m}}{x - {x}_{0 , m}} ) ) \\ k ( y - {y}_{0 , m} ) + {f}_{Y , cde} ( k \sqrt{\begin{matrix}{( x - {x}_{0 , m} )}^{2} + \\ {( y - {y}_{0 , m} )}^{2}\end{matrix}} , {Tan}^{- 1} ( \frac{y - {y}_{0 , m}}{x - {x}_{0 , m}} ) )\end{matrix} ] \qquad EQUATION ( 8 )$$

In step S13, the CPU 451 converts the coordinates in the phases Φₘ (x, y) with use of this equation (8), and corrects the distortion components A3 to A5 illustrated in FIGS. 6C to 6E in addition to the deviation components A1 and A2 illustrated in FIGS. 6A and 6B (a deviation component correction step, or a distortion component correction process). The CPU 451 performs the process in step S13, i.e., deviation component correction processing and distortion component correction processing.

In other words, according to the present exemplary embodiment, the CPU 451 corrects the deviation components A1 and A2 contained in the respective phase distributions Φₘ(x, y). In addition, the CPU 451 corrects the distortion components A3 to A5 contained in the respective phase distributions Φₘ(x, y). Further, the CPU 451 converts the respective phase distributions Φₘ(x, y) in the coordinate system of the camera 440 into the phase distributions Φₘ(X, Y) in the coordinate system on the subject surface W1a at the same time as these corrections.

In step S14, the CPU 451 extracts the phase data φₘ(hₘ cos θ, hₘ sin θ) of the interference fringes corresponding to h=hₘ from the phase distributions Φₘ (X, Y) in which the distortions are corrected in this manner.

After that, in step S15, the CPU 451 calculates the shape data of the whole subject surface W1a from the phase data φₘ(hₘ cos θ, hₘ sin θ) and the wavelength data λₘ in the respective steps m. In other words, the CPU 451 calculates the shape data of the subject surface W1a, which is corrected based on the deviation components A1 and A2 and the distortion components A3 to A5, in steps S13 to S15 (a shape data calculation step, or shape data calculation processing).

This series of measurement processes allows the CPU 451 to calculate the shape data in which the lateral coordinates are accurately corrected.

Further, regarding the distortions contained in the shape data acquired by the scanning interferometer 400, the CPU 451 generates data to be used for the correction after removing the deviation components each having an orientation and an amount both unchangeable along the circumferential direction centered at the optical axis of the interferometer 400 in step S12.

In other words, the deviation of the axis when the subject W1 is scanned is different from the deviation of the axis when the calibrator Ws is scanned, whereby only the distortion components due to the aberration can be acquired by removing the components due to the deviation of the axis when the calibrator Ws is scanned from the distortion data acquired by scanning of the calibrator Ws. The deviation of the axis when the subject W1 is scanned is calculated in step S5, whereby an accurate correction can be made based on results of them. Therefore, the present exemplary embodiment can prevent an erroneous correction from being made regarding the deviation of the axis, thereby preventing the distortions contained in the shape data from increasing.

Further, a more accurate correction can be made, because the distortion components to be used for the correction are calculated by fitting with use of a hypothetical appropriate function in step S12. Further, the distortion components to be corrected can be more easily calculated, because the fitting function is simplified by limiting the distortion components to be used for the correction.

The present exemplary embodiment has described the method for indirectly correcting the lateral coordinates of the shape data by correcting the lateral coordinates of the interference fringe phases, which are original data of the shape data. However, the method for correcting the lateral coordinates is not limited thereto. The lateral coordinates of the shape data formed from the interference fringe phases may be directly corrected based on the distortion data acquired by scanning of the calibrator Ws and an analysis of the interference fringes. Alternatively, the lateral coordinates may be corrected with respect to the images captured by the camera 440, which are original data of the interference fringe phases.

Further, in step S12, the distortion components are calculated with use of the fitting function, but the distortion components may be calculated by, for example, complementing data.

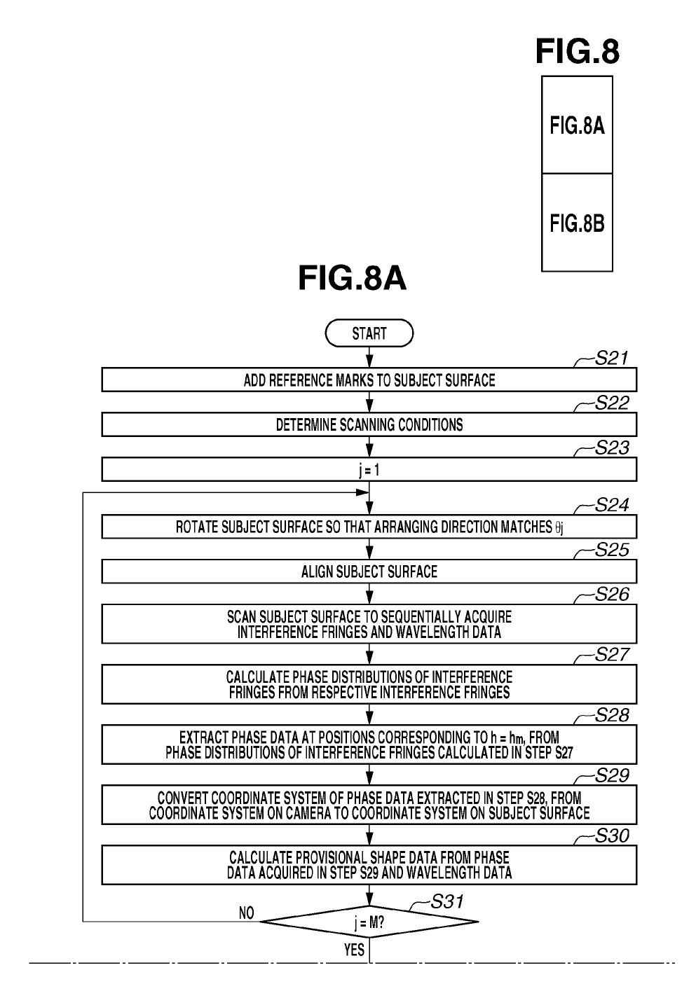

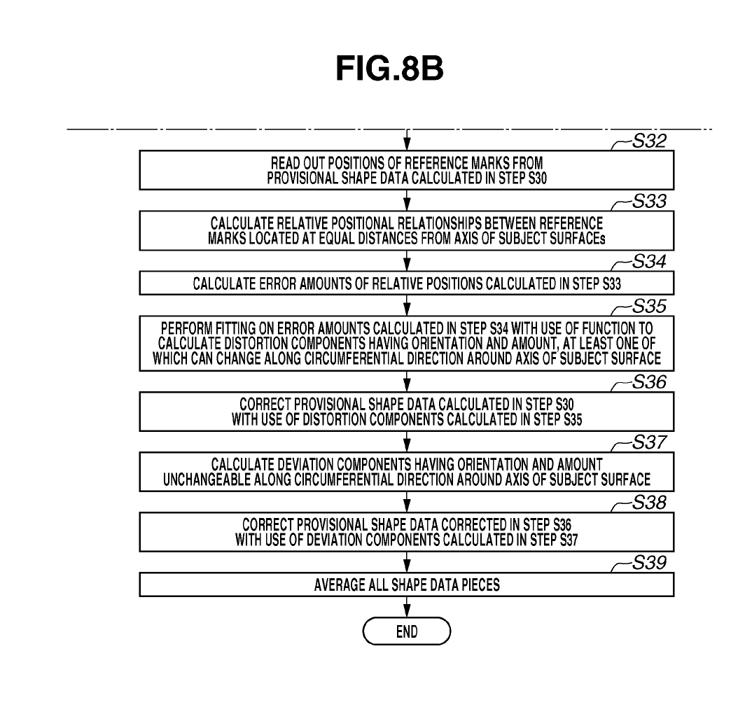

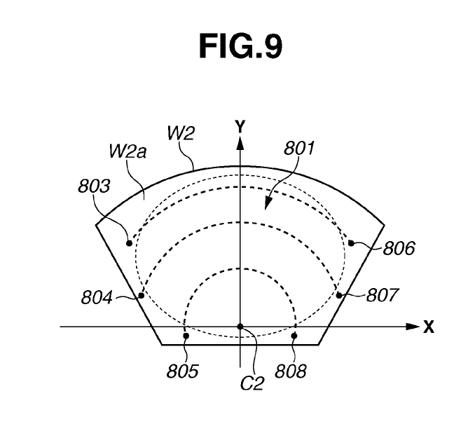

Next, an operation of a shape measurement apparatus according to a second exemplary embodiment of the present invention will be described. The shape measurement apparatus according to the second exemplary embodiment is configured in a similar manner to the shape measurement apparatus 100 according to the above-described first exemplary embodiment illustrated in FIG. 1. FIG. 8 is a flowchart illustrating a shape measurement method performed by the shape measurement apparatus according to the second exemplary embodiment of the present invention. FIG. 9 is a front view of a subject used in shape measurement according to the second exemplary embodiment of the present invention.

Major differences from the above-described first exemplary embodiment are that the subject W2 illustrated in FIG. 9 also functions as the calibrator, which is the lateral coordinate calibrator, the subject W2 is scanned a plurality of times, and an axis (optical axis) C2 of an aspheric subject surface W2a is deviated from a center of an optical effective region 801. However, the design shape of the subject surface W2a is axially symmetric around the optical axis C2 in a similar manner to the above-described first exemplary embodiment, and is expressed as z=z₀(h).

In the following description, a measurement procedure according to the present second exemplary embodiment will be described according to the flowchart illustrated in FIG. 8. First, in step S21, as illustrated in FIG. 9, reference marks 803 to 808 as characteristic points are provided on the subject surface W2a of the subject W2. In the present second exemplary embodiment, small-diameter concaved surface shapes are directly processed on the subject surface W2a, and these shapes are used as the reference marks 803 to 808. However, the reference marks 803 to 808 may be prepared or configured in another manner. Further, the reference marks 803 to 808 are formed in another region than the optical effective region 801 as illustrated in FIG. 9 to prevent impairment of the optical performance of the subject W2.

Further, according to the present second exemplary embodiment, these reference marks 803 to 808 are arranged to be located two by two line-symmetrically around a Y axis at positions where distances h thereof from the axis C2 of the aspheric surface are equal. More specifically, a characteristic point group constituted by a plurality of (two) reference marks 803 and 806 is formed at positions where the distances h thereof from the optical axis C2 of the subject surface W2a are equal. Further, a characteristic point group constituted by a plurality of (two) reference marks 804 and 807 is formed at positions where the distances h thereof from the optical axis C2 of the subject surface W2a are equal. Further, a characteristic point group constituted by a plurality of (two) reference marks 805 and 808 is formed at positions where the distances h thereof from the optical axis C2 of the subject surface W2a are equal. In other words, a plurality of characteristic point groups is formed in the other regions than the optical effective region 801 of the subject surface W2a to be placed by different distances h from the optical axis C2 of the subject surface W2a. In the present second exemplary embodiment, three characteristic point groups are formed.

Suppose that (X_{l,1}, Y_{l,1}) is the position of the reference mark 805. Suppose that (X_{r,1}, Y_{r,1}) is the position of the reference mark 808. Suppose that (X_{l,2}, Y_{l,2}) is the position of the reference mark 804, (X_{r,2}, Y_{r,2}) is the position of the reference mark 807, (X_{l,3}, Y_{l,3}) is the position of the reference mark 803, and (X_{r,3}, Y_{r,3}) is the position of the reference mark 806. These positions are expressed by a following equation equation (9) and equation (10) in an orthogonal coordinate system (X, Y) in which the axis C2 of the aspheric surface is set as an origin thereof.

$$\begin{matrix}[ \begin{matrix}{X}_{1 , k} \\ {Y}_{1 , k}\end{matrix} ] = [ \begin{matrix}{h}_{k} cos ( π - {φ}_{k} \\ {h}_{k} sin ( π - {φ}_{k}\end{matrix} ] ( k = 1 , 2 , 3 ) & EQUATION ( 9 ) \\ [ \begin{matrix}{X}_{r , k} \\ {Y}_{r , k}\end{matrix} ] = [ \begin{matrix}{h}_{k} cos {φ}_{k} \\ {h}_{k} sin {φ}_{k}\end{matrix} ] ( k = 1 , 2 , 3 ) & EQUATION ( 10 )\end{matrix}$$

The arrangement of the reference marks is not limited thereto. Two or more reference marks may be formed at positions where the distances h thereof are equal, and the reference marks do not necessarily have to be arranged line-symmetrically around the Y axis. Further, a maximum value of k may be a value larger than 3.

After the reference marks 803 to 808 are formed, in step S22, scanning conditions under which the subject surface W2a is scanned are determined.

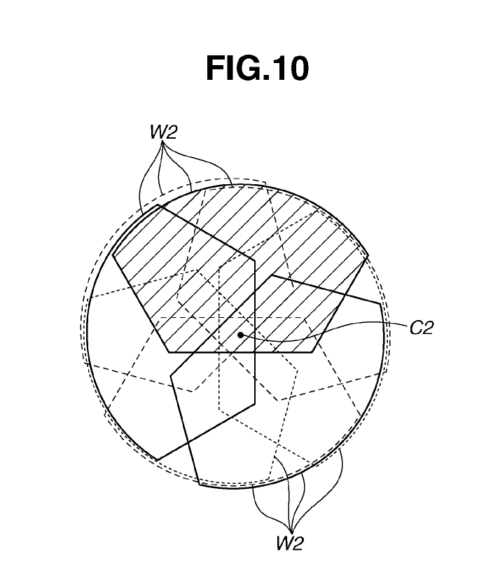

The scanning conditions in the present embodiment are the number of times of scanning M and arranging directions θⱼ of the subject surface W2a at each scanning (j=1, 2, . . . , M), in addition to the number of scanning steps N and the positions Vₘ of the subject surface W2a in the respective steps m. For example, if M is set to 8 and θⱼ is set to π(j−1)/4, the scanning positions are located as illustrated in FIG. 10.

In the present second exemplary embodiment, the subject surface W2a is arranged in different directions and scanning is performed a plurality of times for the purpose of acquiring distortion data over the whole subject surface W2a by referring to only the reference marks 803 to 808 outside the optical effective region 801.

Therefore, it is desirable that the directions θⱼ are evenly distributed as much as possible within a range of 0 to 2π so that the reference marks 803 to 808 scan various positions on a spherical wave. Further, it is desirable that the value of M is determined according to required accuracy for the lateral coordinate calibration.

After the scanning conditions are determined, first, in step S23, the variable j is set to 1. Then, in step S24, the subject surface W2a is arranged in such a manner that the arranging direction matches the direction θⱼ (firstly, j is set to 1). Then, in step S25, the subject surface W2a is aligned in a similar manner to the above-described first exemplary embodiment. Next, in step S26, the CPU 451 sequentially acquires interference fringes and wavelength values according to the determined scanning conditions N and Vₘ.

More specifically, the camera 440 images interference fringes generated from interference between the subject light and the reference light at the respective scanning positions when the subject surface W2a is scanned relative to the reference spherical surface 407a along the optical axis C2 to capture images, and the CPU 451 acquires the captured images from the camera 440. Further, in step S26, the CPU 451 acquires wavelength data from the wavemeter 430 in addition to acquiring the captured images from the camera 440. This step S26 corresponds to an image acquisition step or a wavelength acquisition step or, i.e., image acquisition processing and wavelength acquisition processing, which are performed by the CPU 451.

Next, in step S27, after acquiring the interference fringes and the wavelengths, the CPU 451 acquires interference fringe phases Φⱼ, (x, y) of regions where the interference fringes are sparse in a similar manner to the above-described first exemplary embodiment (a phase distribution calculation step, phase distribution calculation processing). More specifically, the CPU 451 extracts ring zone regions where the interference fringes are sparse in the captured images, from the respective images captured in step S26, and calculates the phase distributions Φ_{j,m}(x, y) of the interference fringes in the respective ring zone regions. Next, in step S28, the CPU 451 extracts phase data Φ_{j,m}(x_{0,m}+(hₘ/k)cos θ, y_{0,m}+(hₘ/k)sin θ) corresponding to the phase distribution of the interference fringe on the circle 502 illustrated in FIG. 4.

After that, in step S29, the CPU 451 converts the coordinate systems of these interference fringes into the coordinate systems on the subject surface W2a, and sets them as phase data θ_{j,m}(hₘ cos θ, hₘ sin θ). Then, in step S30, the CPU 451 generates provisional shape data by using them together with the wavelength data.

After calculating the provisional shape data, in step S31, the CPU 451 determines whether the variable j reaches M. If the variable j does not reach M (NO in step S31), the CPU 451 sets j to j+1, i.e., increments the variable j by one. Then, the processing proceeds to step S24 again. After that, steps S24 to S30 are repeated according to the flowchart. In other words, the CPU 451 acquires, from the camera 440, the images captured at the respective scanning positions of scanning when the scanning is performed a plurality of times while the rotational position of the subject surface W2a is changed around the optical axis C2 of the subject surface W2a, by repeating steps S24 to S30.

By performing the above-described operation, the CPU 451 calculates M pieces of provisional shape data. These provisional shape data pieces each contain a lateral coordinate error due to the deviation components A1 and A2 illustrated in FIGS. 6A and 6B, which are caused by a deviation of the optical axis and an aberration of the optical system, and a lateral coordinate error due to the distortion components A3 to A5 illustrated in FIGS. 6C to 6E, which are caused by the aberration of the optical system. The lateral coordinate error due to the deviation components A1 and A2 illustrated in FIGS. 6A and 6B is different among the respective shape data pieces. The lateral coordinate error due to the distortion components A3 to A5 illustrated in FIGS. 6C to 6E is common among the respective shape data pieces.

These errors are corrected by referring to the positions of the reference marks 803 to 808 in the provisional shape data. As a procedure therefor, first, the distortion components A3 to A5 illustrated in FIGS. 6C to 6E, which are common among the respective shape data pieces, are corrected. After that, the deviation components A1 and A2 illustrated in FIGS. 6A and 6B, which are different among the respective shape data pieces, are corrected.

First, in step S32, the CPU 451 reads out the positions of the reference marks 803 to 808 from the respective shape data pieces to acquire the distortion components A3 to A5 illustrated in FIGS. 6C to 6E. In other words, the CPU 451 calculates the positions of the respective reference marks 803 to 808 from the respective images captured in step S26 (a characteristic point group calculation step, or characteristic point group calculation processing).

The reference marks 803 to 808 can be read out by, for example, performing fitting on shape data around the reference marks 803 to 808 based on the design shapes of the reference marks 803 and 808, and acquiring central positions thereof. In this manner, the CPU 451 calculates the positions of the reference marks 803 to 808 (X′_{l,j,k}, Y′_{l,j,k}) and (X′_{r,j,k}, Y′_{r,j,k}) (k=1, 2, 3, and j=1, 2, . . . , M).

However, these calculated positions of the reference marks 803 to 808 are affected by not only the distortion components A3 to A5 illustrated in FIGS. 6C to 6E but also the deviation components A1 and A2 illustrated in FIGS. 6A and 6B, and how much they are affected thereby varies among the respective shape data pieces. The positions of the reference marks 803 to 808 in different shape data pieces should be referred to in order to acquire the distortion components A3 to A5 illustrated in FIGS. 6C to 6E over the whole subject surface W2a from the reference marks 803 to 808 in the limited region outside the optical effective region 801.

Therefore, the CPU 451 utilizes a relative positional relationship between the reference marks having an identical value h, which is unaffected by the deviation components A1 and A2 illustrated in FIGS. 6A and 6B, to acquire the distortion components A3 to A5 illustrated in FIGS. 6C to 6E. More specifically, in step S33, the CPU 451 calculates a relative position (X′_{j,1}, Y′_{j,1}) of the reference mark 806 relative to the reference mark 803 according to an equation (11). Further, the CPU 451 calculates a relative position (X′_{j,2}, Y′_{j,2}) of the reference mark 807 relative to the reference mark 804 according to the equation (11). Further, the CPU 451 calculates a relative position (X′_{j,3}, Y′_{j,3}) of the reference mark 808 relative to the reference mark 805 according to the equation (11) (a relative position calculation step, or relative position calculation processing).

$$[ \begin{matrix}{X}_{j , k}^{′} \\ {Y}_{j , k}^{′}\end{matrix} ] = [ \begin{matrix}{X}_{r , j , k}^{′} - {X}_{l , j , k}^{′} \\ {Y}_{r , j , k}^{′} - {Y}_{l , j , k}\end{matrix} ] \qquad EQUATION ( 11 )$$

In other words, the CPU 451 refers to the calculated positions of the two reference marks 803 and 806, and acquires a relative position of the calculated position of one of them relative to the calculated position of the other of them. Similarly, the CPU 451 refers to the calculated positions of the two reference marks 804 and 807, and acquires a relative position of the calculated position of one of them relative to the calculated position of the other of them. Similarly, the CPU 451 refers to the calculated positions of the two reference marks 805 and 808, and acquires a relative position of the calculated position of one of them relative to the calculated position of the other.

(X₁, Y₁) is an actual relative position of the reference mark 806 relative to the reference mark 803, (X₂, Y₂) is an actual relative position of the reference mark 807 relative to the reference mark 804, and (X₃, Y₃) is an actual relative position of the reference mark 808 relative to the reference mark 805. These relative positions are calculated by an equation (12) from the equations (9) and (10). The actual relative positions (Xₖ, Yₖ) may be stored in a storage unit such as the HDD 454 in advance and may be read out from the storage unit by the CPU 451, or may be acquired from an external apparatus. Alternatively, the actual positions (X_{l,k}, Y_{l,k}) and (X_{r,k}, Y_{r,k}) may be stored in a storage unit such as the HDD 454 in advance, and the CPU 451 may read out them from the storage unit to calculate the relative positions (Xₖ, Yₖ). Further alternatively, the CPU 451 may acquire data of the actual positions (X_{l,k}, Y_{l,k}) and (X_{r,k}, Y_{r,k}) from an external apparatus to calculate the relative positions (Xₖ, Yₖ). Further alternatively, the CPU 451 may acquire data of hₖ and φₖ from a storage unit such as the HDD 454 or an external apparatus to calculate the relative positions (Xₖ, Yₖ).

$$[ \begin{matrix}{X}_{k} \\ {Y}_{k}\end{matrix} ] = [ \begin{matrix}2 {h}_{k} cos {φ}_{k} \\ 0\end{matrix} ] \qquad EQUATION ( 12 )$$

In step S34, the CPU 451 calculates an error amount (ΔX_{j,1}, ΔY_{j,1}) of the relative position of the reference mark 806 relative to the reference mark 803 in the provisional shape data according to an equation (13). Similarly, the CPU 451 calculates an error amount (ΔX_{j,2}, ΔY_{j,2}) of the relative position of the reference mark 807 relative to the reference mark 804 according to the equation (13). Similarly, the CPU 451 calculates an error amount (ΔX_{j,3}, ΔY_{j,3}) of the relative position of the reference mark 808 relative to the reference mark 805 according to the equation (13) (a relative error calculation step, or relative error calculation processing). In other words, the CPU 451 calculates errors between the relative positions calculated in step S33 and the actual relative positions.

$$[ \begin{matrix}Δ {X}_{j , k} \\ Δ {Y}_{j , k}\end{matrix} ] = [ \begin{matrix}{X}_{j , k}^{′} - 2 {h}_{k} cos {φ}_{k} \\ {Y}_{j , k}^{′}\end{matrix} ] \qquad EQUATION ( 13 )$$

The errors (ΔX_{j,k}, ΔY_{j,k}) are distortion data that contains information regarding distortions contained in the provisional shape data. However, they are deviation amounts of the relative positions between the points away from the axis C2 of the subject surface W2a by an equal distance. Therefore, they do not contain the deviation components A1 and A2 illustrated in FIGS. 6A and 6B, and contain only the distortion components A3 to A5 illustrated in FIGS. 6C to 6E, in which at least one of the orientation and the amount is changeable along the circumferential direction.

Therefore, in step S35, the CPU 451 extracts the components A3 to A5 illustrated in FIGS. 6C to 6E, which are contained in the respective shape data pieces, by collectively analyzing the errors (ΔX_{j,k}, ΔY_{j,k})(j=1, 2, . . . , M, and k=1, 2, 3). In this analysis, the CPU 451 performs fitting with respect to the errors (ΔX_{j,k}, ΔY_{j,k}) with use of an equation (14) (a distortion component calculation step, or distortion component calculation processing). More specifically, the CPU 451 fits to the errors calculated in step S34 a fitting function containing a function corresponding to the distortion components each having an orientation and an amount, at least one of which is changeable along the circumferential direction of the circle centered at the optical axis of the subject light. Then, the CPU 451 calculates (extracts) the distortion components from the fitting function after the fitting is performed.

$$[ \begin{matrix}Δ {X}_{j , k} \\ Δ {Y}_{j , k}\end{matrix} ] = [ \begin{matrix}cos {θ}_{j} & sin {θ}_{j} \\ - sin {θ}_{j} & cos {θ}_{j}\end{matrix} ] [ \begin{matrix}{f}_{x , cde} ( {h}_{k} , {φ}_{k} + {θ}_{j} ) - {f}_{x , cde} ( {h}_{k} , π - {φ}_{k} + {θ}_{j} ) \\ {f}_{y , cde} ( {h}_{k} , {φ}_{k} + {θ}_{j} ) - {f}_{y , cde} ( {h}_{k} , π - {φ}_{k} + {θ}_{j} )\end{matrix} ] \qquad EQUATION ( 14 )$$

According to this method, the CPU 451 can extract the distortion components A3 to A5 illustrated in FIGS. 6C to 6E without being affected by the deviation amounts A1 and A2 illustrated in FIGS. 6A and 6B. The CPU 451 calculates the distortion components with use of the fitting function in step S35, but may calculate the distortion components by, for example, complementing the data.

The CPU 451 converts the lateral coordinates in the respective shape data piece with use of the thus-calculated distortion data (f_{x,cde}(h, θ), f_{y,cde} (h, θ)) according to an equation (15).

$$[ \begin{matrix}X \\ Y\end{matrix} ] \to [ \begin{matrix}X \\ Y\end{matrix} ] - [ \begin{matrix}cos {θ}_{j} & sin {θ}_{j} \\ - sin {θ}_{j} & cos {θ}_{j}\end{matrix} ] [ \begin{matrix}{f}_{x , cde} ( \sqrt{{X}^{2} + {Y}^{2}} , {Tan}^{- 1} ( \frac{Y}{X} ) + {θ}_{j} ) \\ {f}_{y , cde} ( \sqrt{{X}^{2} + {Y}^{2}} , {Tan}^{- 1} ( \frac{Y}{X} ) + {θ}_{j} )\end{matrix} ] \qquad EQUATION ( 15 )$$

Based on this coordinate conversion, in step S36, the CPU 451 corrects the distortion components A3 to A5 illustrated in FIGS. 6C to 6E, which are contained in the respective shape data pieces (a distortion component correction step, distortion component correction processing).

After correcting the distortion components A3 to A5 illustrated in FIGS. 6C to 6E, which are common among the respective shape data pieces, in step S37, the CPU 451 calculates the deviation components by an image analysis before correcting the deviation components A1 and A2 illustrated in FIGS. 6A and 6B, which are different among the respective shape data pieces. This step S37 corresponds to a deviation component analysis step or deviation component analysis processing, which are performed by the CPU 451.

First, the CPU 451 calculates positions (X″_{l,j,k}, Y″_{l,j,k}) and (X″_{r,j,k}, Y″_{r,j,k}) of the reference marks 803 to 808 in the shape data in which the distortion components A3 to A5 illustrated in FIGS. 6C to 6E are corrected, according to equations (16) and (17). In other words, the CPU 451 corrects the positions of the respective reference marks 803 to 808 calculated in step S32 based on the distortion components calculated in step S35. As a result, the calculated position data of the reference marks 803 to 808 contain only errors of the deviation amounts while the errors of the distortion components are removed therefrom.

$$\begin{matrix}[ \begin{matrix}{X}_{l , j , k}^{″} \\ {Y}_{l , j , k}^{″}\end{matrix} ] = [ \begin{matrix}{X}_{l , j , k}^{′} \\ {Y}_{l , j , k}^{′}\end{matrix} ] - [ \begin{matrix}cos {θ}_{j} & sin {θ}_{j} \\ - sin {θ}_{j} & cos {θ}_{j}\end{matrix} ] [ \begin{matrix}{f}_{x , cde} ( {h}_{k} , π - {φ}_{k} + {θ}_{j} \\ {f}_{y , cde} ( {h}_{k} , π - {φ}_{k} + {θ}_{j}\end{matrix} ] & EQUATION ( 16 ) \\ [ \begin{matrix}{X}_{r , j , k}^{″} \\ {Y}_{r , j , k}^{″}\end{matrix} ] = [ \begin{matrix}{X}_{r , j , k}^{′} \\ {Y}_{r , j , k}^{′}\end{matrix} ] - [ \begin{matrix}cos {θ}_{j} & sin {θ}_{j} \\ - sin {θ}_{j} & cos {θ}_{j}\end{matrix} ] [ \begin{matrix}{f}_{x , cde} ( {h}_{k} , {φ}_{k} + {θ}_{j} \\ {f}_{y , cde} ( {h}_{k} , {φ}_{k} + {θ}_{j}\end{matrix} ] & EQUATION ( 17 )\end{matrix}$$

Next, the CPU 451 calculates amounts ΔXⱼ(hₖ) and ΔY (hₖ) of the components A1 and A2 illustrated in FIGS. 6A and 6B at h=hₖ in the respective shape data pieces according to an equation (18).

$$[ \begin{matrix}Δ {X}_{j} ( {h}_{k} ) \\ Δ {Y}_{j} ( {h}_{k} )\end{matrix} ] = [ \begin{matrix}\frac{1}{2} ( {X}_{r , j , k}^{″} + {X}_{r , j , k}^{″} ) \\ \frac{1}{2} ( {Y}_{r , j , k}^{″} + {Y}_{r , j , k}^{″} ) - {h}_{k} sin {φ}_{k}\end{matrix} ] \qquad EQUATION ( 18 )$$

The CPU 451 calculates the amounts ΔXⱼ(h) and ΔYⱼ(h) of the deviation components A1 and A2 illustrated in FIGS. 6A and 6B over the whole subject surface W2a by performing fitting on these amounts ΔXⱼ(hₖ) and ΔYⱼ(hₖ) with use of an equation (19). In other words, the CPU 451 calculates the deviation components based on the corrected calculated positions of the respective reference marks 803 to 808.

$$[ \begin{matrix}Δ {X}_{j} ( h ) \\ Δ {Y}_{j} ( h )\end{matrix} ] = {\sum }_{i = 0 , 1 , 2} {k}_{j , a , i} {h}^{i} [ \begin{matrix}1 \\ 0\end{matrix} ] + {\sum }_{i = 0 , 1 , 2} {k}_{j , b , i} {h}^{i} [ \begin{matrix}0 \\ 1\end{matrix} ] \qquad EQUATION ( 19 )$$

In step S38, the CPU 451 uses these amounts ΔXⱼ(h) and ΔYⱼ(h) to convert the lateral coordinates in the respective shape data pieces in which the distortion components A3 to A5 illustrated in FIGS. 6C to 6E are corrected according to an equation (20), thereby removing the deviation components A1 and A2 illustrated in FIGS. 6A and 6B. In other words, the CPU 451 corrects the provisional shape data corrected in step S36, based on the deviation components calculated in step S37 (a deviation component correction step or deviation component correction processing).

$$[ \begin{matrix}X \\ Y\end{matrix} ] \to [ \begin{matrix}X - Δ {X}_{j} ( \sqrt{{X}^{2} + {Y}^{2}} ) \\ Y - Δ {Y}_{j} ( \sqrt{{X}^{2} + {Y}^{2}} )\end{matrix} ] \qquad EQUATION ( 20 )$$

Lastly, in step S39, the CPU 451 averages the acquired M shape data pieces to calculate a single shape data piece. In other words, the CPU 451 calculates shape data of the subject surface W2a corrected based on the deviation components A1 and A2 and the distortion components A3 to A5 by performing steps S35 to S39 (a shape data calculation step or shape data calculation processing).

In this manner, the present second exemplary embodiment can calculate shape data with the lateral coordinates accurately corrected by this series of measurement operations.

An experiment of aspheric interference measurement was conducted to compare the lateral coordinate accuracy of the shape data between measurement that uses this method and measurement that does not use this method. As a result of this experiment, it was confirmed that the measurement that does not use the present second exemplary embodiment had a lateral coordinate error of 100 μm or more, while use of the present second exemplary embodiment could reduce this error to 20 μm or less. This indicates that the present second exemplary embodiment is largely effective in reducing a lateral coordinate error in aspheric interference measurement.

Further, according to the present second exemplary embodiment, the CPU 451 calculates the relative positional relationship among the plurality of lateral coordinate references placed by an equal distance from the central point, when calculating the distortion components. At this time, since no complicated calculation is required, the distortion components can be more easily calculated.

Further, according to the present second exemplary embodiment, the distortions contained in the shape data are corrected with use of the plurality of deviation and distortion components, and therefore can be corrected more accurately.

Further, according to the present second exemplary embodiment, since the deviation components and the distortion components are acquired while the subject surface W2a is scanned at various positions, the distortions contained in the shape data can be corrected more accurately.

Further, according to the present second exemplary embodiment, since an additional lateral coordinate calibrator does not have to be newly prepared, a cost reduction can be realized.

In the present second exemplary embodiment, the distortions in the shape data are directly corrected with use of the distortion data acquired from the positions of the reference marks. However, the correction method is not limited thereto. The distortions in the interference fringe phase data may be corrected with use of the acquired distortion data, and the shape data may be formed from this interference fringe phase data. Alternatively, the distortions in the captured images may be corrected, and the interference fringe phase data may be calculated therefrom. After that, the shape data may be formed.

A third exemplary embodiment will be described as follows. A surface shape measurement apparatus according to the third exemplary embodiment is also configured in a similar manner to the shape measurement apparatus 100 according to the above-described first exemplary embodiment illustrated in FIG. 1. However, the third exemplary embodiment is different from the above-described first exemplary embodiment in terms of an operation of the CPU 451 of the controller 450, i.e., the program 457.

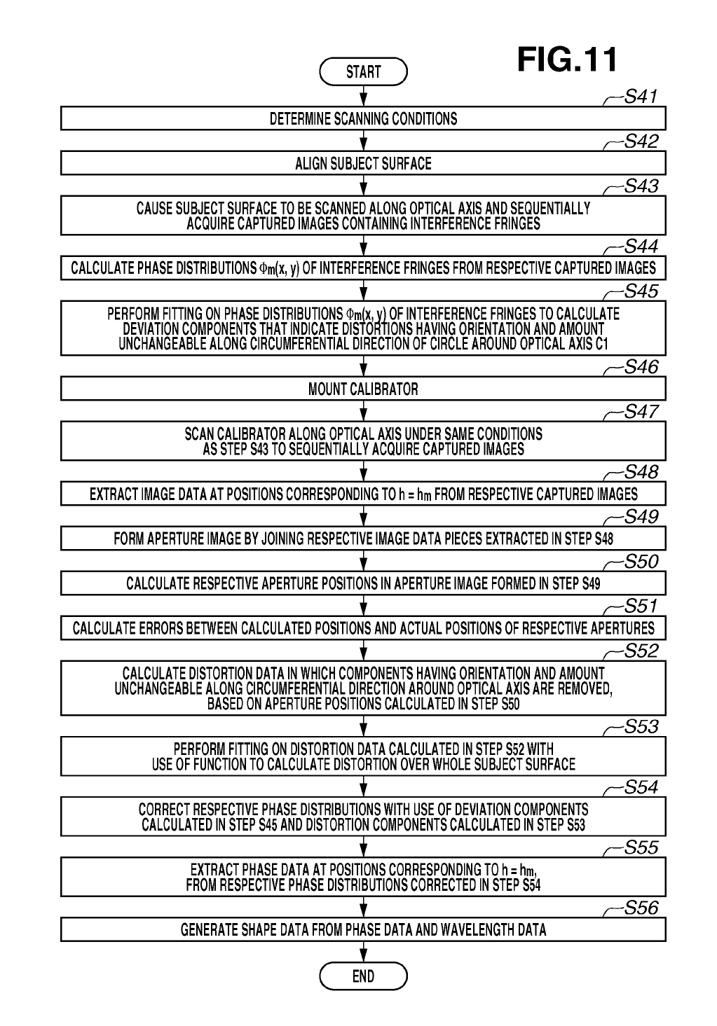

FIG. 11 is a flowchart illustrating a shape measurement method performed by the shape measurement apparatus according to the third exemplary embodiment of the present invention.

A procedure according to the present third exemplary embodiment is performed according to the flowchart illustrated in FIG. 11, and steps S41 to S51 are similar to steps S1 to S11. However, 2π/Δθ should be an even number.

After calculating the deviations of the aperture positions (errors or distortion data) in step S51, in step S52, the CPU 451 calculates distortion data ΔX′(pΔh, qΔθ) and ΔY′(pΔh, qΔθ) in which the deviation components A1 and A2 illustrated in FIGS. 6A and 6B are removed, according to an equation (21).

$$[ \begin{matrix}Δ {X}^{′} ( p Δ h , q Δ θ ) \\ Δ {Y}^{′} ( p Δ h , q Δ θ )\end{matrix} ] = [ \begin{matrix}Δ X ( p Δ h , q Δ θ ) \\ Δ Y ( p Δ h , q Δ θ )\end{matrix} ] - {\sum }_{{q}^{′} = 1}^{2 π / Δ θ} Δ X ( p Δ h , {q}^{′} Δ θ ) [ \begin{matrix}1 \\ 0\end{matrix} ] - {\sum }_{{q}^{′} = 1}^{2 π / Δ θ} Δ Y ( p Δ h , {q}^{′} Δ θ ) [ \begin{matrix}0 \\ 1\end{matrix} ] \qquad EQUATION ( 21 )$$

In the equation (21), the second and third terms on the right side indicate overall positional deviations of 2π/δθ apertures arranged at positions placed by an equal distance (=pΔh) from the axis of the aspheric surface, i.e., indicate the deviation components A1 and A2 illustrated in FIGS. 6A and 6B, each of which has an orientation and an amount unchangeable along the circumferential direction centered at the optical axis. The distortion data ΔX′(pΔh, qΔθ) and ΔY′(pΔh, qΔθ) in which the deviation components are removed corresponds to distortion data that indicates a relative positional relationship among the 2π/Δθ marks.

After extracting the deviation components each having an orientation and an amount unchangeable along the circumferential direction centered at the optical axis, in step S53, the CPU 451 performs fitting thereon with use of the equation (7) to calculate the distortion data (the distortion components) over the whole subject surface W1a.

After that, the CPU 451 calculates the shape data of the subject surface W1a according to steps S54 to S56, which are similar to steps S13 to S15.

The present invention is not limited to the above-described exemplary embodiments, and can be modified in a number of manners within the technical idea of the present invention by a person having ordinary knowledge in the art to which the present invention pertains.

Specifically, each processing operation in the above-described exemplary embodiments is performed by the CPU 451 serving as the calculation unit of the controller 450. Therefore, the above-described exemplary embodiments may be also achieved by supplying a recording medium storing a program capable of realizing the above-described functions to the controller 450, and causing the computer (the CPU or a micro processing unit (MPU)) of the controller 450 to read out the program stored in the recording medium to execute it. In this case, the program itself read out from the recording medium realizes the functions of the above-described exemplary embodiments, and the program itself and the recording medium storing this program constitute the present invention.

Further, the above-described exemplary embodiments have been described based on the example in which the computer-readable recording medium is the HDD 454, and the program 457 is stored in the HDD 454. However, the present invention is not limited thereto. The program 457 may be recorded in any recording medium as long as this recording medium is a computer-readable recording medium. For example, the ROM 452, the external storage device 480, and the recording disk 458 illustrated in FIG. 2 may be used as the recording medium for supplying the program. Specific examples usable as the recording medium include a flexible disk, a hard disk, an optical disk, a magnetic optical disk, a compact disk (CD)-ROM, a CD-recordable (R), a magnetic tape, a nonvolatile memory card, and a ROM.

Further, the above-described exemplary embodiments may be realized in such a manner that the program in the above-described exemplary embodiments is downloaded via a network, and is executed by the computer.

Further, the present invention is not limited to the embodiments in which the computer reads and executes the program code, thereby realizing the functions of the above-described exemplary embodiments. The present invention also includes an embodiment in which an operating system (OS) or the like running on the computer performs a part or whole of actual processing based on an instruction of the program code, and this processing realizes the functions of the above-described exemplary embodiments.

Further, the program code read out from the recording medium may be written in a memory provided in a function extension board inserted into the computer or a function extension unit connected to the computer. The present invention also includes an embodiment in which a CPU or the like provided in this function extension board or function extension unit performs a part or whole of the actual processing based on the instruction of the program code, and this processing realizes the functions of the above-described exemplary embodiments.

According to the present invention, since the deviation of the scanning axis and the deviation due to the aberration and the like are corrected, the shape data can be more accurately acquired than the conventional techniques.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-029575 filed Feb. 19, 2013, which is hereby incorporated by reference herein in its entirety.

What is claimed is:

1. A shape measurement method comprising:
emitting subject light as a spherical wave to an aspheric subject surface;
causing the subject surface to be scanned relative to a reference spherical surface that faces the subject surface along an optical axis of the subject light; and
acquiring shape data of the subject surface by a calculation unit based on phase data of an interference fringe generated when the subject light reflected by the subject surface and reference light reflected by the reference spherical surface interfere with each other,
wherein the shape measurement method further comprises:
causing an imaging unit to image the interference fringe generated from interference between the subject light and the reference light at each scanning position when the subject surface is scanned relative to the reference spherical surface along the optical axis of the subject light to form a captured image, and
acquiring the captured image from the imaging unit;
causing the calculation unit to extract a ring zone region where the interference fringe is sparse in the captured image from each image captured in the image acquisition, and calculate a phase distribution of the interference fringe in each ring zone region;
performing a deviation component analysis, in which the calculation unit acquires a deviation component having an orientation and an amount both unchangeable along a circumferential direction of a circle centered at the optical axis of the subject light by analyzing the interference fringe contained in each image captured in the image acquisition;
performing calibrator image acquisition, in which, after the imaging unit images an interference fringe generated from interference between reflection light from a calibrator and reflection light from the reference special surface at each scanning position when the calibrator having a plurality of characteristic points is scanned relative to the reference spherical surface to form a captured image, the calculation unit acquires the captured image from the imaging unit;
causing the calculation unit to calculate positions of the respective characteristic points from each image captured in the calibrator image acquisition;
causing the calculation unit to calculate errors between the calculated positions of the respective characteristic points and actual positions of the respective characteristic points;
performing a distortion component calculation, in which the calculation unit calculates a distortion component having an orientation and an amount, at least one of which is changeable along the circumferential direction of the circle centered at the optical axis of the subject light, based on the errors; and
causing the calculation unit to calculate the shape data corrected based on the deviation component and the distortion component.

2. The shape measurement method according to claim 1, wherein, in the distortion component calculation, the calculation unit fits a fitting function containing a function corresponding to the distortion component to the errors, and calculates the distortion component from the fitting function after the fitting.

3. The shape measurement method according to claim 1, wherein, in the deviation component analysis, the calculation unit calculates a deviation amount of a central axis of each phase distribution from a reference point as the deviation component.

4. A shape measurement method comprising:
emitting subject light as a spherical wave to an aspheric subject surface;
causing the subject surface to be scanned relative to a reference spherical surface that faces the subject surface along an optical axis of the subject light; and
acquiring shape data of the subject surface by a calculation unit based on phase data of an interference fringe generated when the subject light reflected by the subject surface and reference light reflected by the reference spherical surface interfere with each other,
wherein the shape measurement method further comprises:
preparing a characteristic point group constituted by a plurality of characteristic points at positions placed by an equal distance from an optical axis of the subject surface, in the other regions than an optical effective region of the subject surface;
causing an imaging unit to image the interference fringe generated from interference between the subject light and the reference light at each scanning position when the subject surface is scanned relative to the reference spherical surface along the optical axis of the subject light to form a captured image, and acquiring the captured image from the imaging unit;
causing the calculation unit to extract a ring zone region where the interference fringe is sparse in the captured image from each image captured in the image acquisition, and calculate a phase distribution of the interference fringe in each ring zone region;
performing a deviation component analysis, in which the calculation unit acquires a deviation component having an orientation and an amount both unchangeable along a circumferential direction of a circle centered at the optical axis of the subject light by analyzing the interference fringe contained in each image captured in the image acquisition;
causing the calculation unit to calculate positions of the respective characteristic points from each image captured in the image acquisition;
performing a relative position calculation, in which the calculation unit calculates a relative position of the calculated position of one characteristic point relative to the calculated position of another characteristic point among the calculated positions of the plurality of characteristic points;
performing a relative error calculation, in which the calculation unit calculates an error between the relative positions calculated in the relative position calculation and an actual relative position;
performing a distortion component calculation, in which the calculation unit calculates a distortion component having an orientation and an amount, at least one of which is changeable along the circumferential direction of the circle centered at the optical axis of the subject light based on the error; and
causing the calculation unit to calculate the shape data corrected based on the deviation component and the distortion component.

5. The shape measurement method according to claim 4, wherein, in the distortion component calculation, the calculation unit fits a fitting function containing a function corresponding to the distortion component to the error, and calculates the distortion component from the fitting function after the fitting.

6. The shape measurement method according to claim 4, wherein, in the deviation component analysis, the calculation unit calculates the deviation component based on the calculated positions of the respective characteristic points acquired by correcting the calculated positions of the respective characteristic points calculated in the characteristic point group calculation based on the distortion component calculated in the distortion component calculation.

7. The shape measurement method according to claim 4, wherein, in the image acquisition, the calculation unit acquires the image captured by the imaging unit at each scanning position when the subject surface is scanned a plurality of times while changing a rotational position of the subject surface around the optical axis of the subject surface.

8. The shape measurement method according to claim 4, wherein, as the characteristic point group, a plurality of characteristic point groups is formed so as to be placed by different distances from the optical axis of the subject surface in the other region than the optical effective region on the subject surface.

9. A shape measurement apparatus configured to measure a shape of an aspheric subject surface, comprising:
a laser light source;
a Fizeau lens having a reference spherical surface, configured to transmit laser light emitted from the laser light source to the subject surface as subject light which is a spherical wave, and configured to generate an interference fringe from interference between the subject light reflected by the subject surface and reference light reflected by the reference spherical surface;
a scanning unit configured to scan the subject surface relative to the reference spherical surface along an optical axis of the subject light;
an imaging unit configured to image the interference fringe from the Fizeau lens; and
a calculation unit configured to acquire shape data of the subject surface based on phase data of the interference fringe,
wherein the calculation unit performs image acquisition processing for acquiring a image captured by the imaging unit at each scanning position when the subject surface is scanned relative to the reference spherical surface along the optical axis of the subject light from the imaging unit,
phase distribution calculation processing for extracting a ring zone region where the interference fringe is sparse in the captured image from each image captured in the image acquisition processing, and calculating a phase distribution of the interference fringe in each ring zone region,
deviation component analysis processing for acquiring a deviation component having an orientation and an amount both unchangeable along a circumferential direction of a circle centered at the optical axis of the subject light by analyzing the interference fringe contained in each image captured in the image acquisition processing,
calibrator image acquisition processing for acquiring the captured image from the imaging unit, after the imaging unit images an interference fringe generated from interference between reflection light from a calibrator and reflection light from the reference special surface at each scanning position when the calibrator having a plurality of characteristic points is scanned relative to the reference spherical surface to form a captured image,
characteristic point position calculation processing for calculating positions of the respective characteristic points from each image captured in the calibrator image acquisition processing,
error calculation processing for calculating errors between the calculated positions of the respective characteristic points and actual positions of the respective characteristic points,
distortion component calculation processing for calculating a distortion component having an orientation and an amount, at least one of which is changeable along the circumferential direction of the circle centered at the optical axis of the subject light, based on the errors, and
shape data calculation processing for calculating the shape data corrected based on the deviation component and the distortion component.

10. A shape measurement apparatus configured to measure a shape of an aspheric subject surface, comprising:
a laser light source;
a Fizeau lens having a reference spherical surface, configured to transmit laser light emitted from the laser light source to the subject surface as subject light which is a spherical wave, and configured to generate an interference fringe from interference between the subject light reflected by the subject surface and reference light reflected by the reference spherical surface;
a scanning unit configured to scan the subject surface relative to the reference spherical surface along an optical axis of the subject light;
an imaging unit configured to image the interference fringe from the Fizeau lens; and
a calculation unit configured to acquire shape data of the subject surface based on phase data of the interference fringe,
wherein a characteristic point group constituted by a plurality of characteristic points is formed at positions placed by an equal distance from an optical axis of the subject surface, in the other regions than an optical effective region of the subject surface, and
wherein the calculation unit performs image acquisition processing for acquiring a image captured by the imaging unit at each scanning position when the subject surface is scanned relative to the reference spherical surface along an optical axis of the subject light from the imaging unit,
phase distribution calculation processing for extracting a ring zone region where the interference fringe is sparse in the captured image from each image captured in the image acquisition processing, and calculating a phase distribution of the interference fringe in each ring zone region,
deviation component analysis processing for acquiring a deviation component having an orientation and an amount both unchangeable along a circumferential direction of a circle centered at the optical axis of the subject light by analyzing the interference fringe contained in each image captured in the image acquisition processing,
characteristic point group calculation processing for calculating positions of the respective characteristic points from each image captured in the image acquisition processing,
relative position calculation processing for calculating a relative position of the calculated position of one characteristic point relative to the calculated position of another characteristic point among the calculated positions of the plurality of characteristic points,
relative error calculation processing for calculating an error between the relative positions calculated in the relative position calculation processing and an actual relative position,
distortion component calculation processing for calculating a distortion component having an orientation and an amount, at least one of which is changeable along the circumferential direction of the circle centered at the optical axis of the subject light, based on the error, and
shape data calculation processing for calculating the shape data corrected based on the deviation component and the distortion component.

11. A program for causing a computer to perform the shape measurement method according to claim 1.

12. A computer readable recording medium storing the program according to claim 11.
